(19) United States
(12) Patent Application Publication
(10) Pub. No.: US 2020/0324844 A1
(43) Pub. Date: Oct. 15, 2020

(54) A PERSONAL TRANSPORTER

(71) Applicant: HANGAR 23 PTY LTD, COOMERA,QLD (AU)

(72) Inventors: Brian MACDONALD, Brisbane (AU); Chris O'NEILL, Brisbane (AU); Dallyn SEALE, Brisbane (AU)

(21) Appl. No.: 16/305,139

(22) PCT Filed: May 29, 2017
(86) PCT No.: PCT/AU2017/050502

§ 371 Date: Nov. 28, 2018

(30) Foreign Application Priority Data
Jun. 1, 2016 (AU) 2016902094
Aug. 19, 2016 (AU) 2016101478
Dec. 8, 2016 (AU) 2016905060

(51) Int. Cl. B62K 5/027; B62D 51/02; B60L 7/10; B62K 21/12; B62J 27/00; A61G 3/06; A61G 3/08; B62K 5/025; B62M 7/12; B62K 5/06; B62J 9/27; B62J 9/28; B62J 9/30; B62J 45/42; B62J 45/20

(52) U.S. Cl. CPC B62K 5/027; B62K 27/003; B60L 7/10; B62K 21/12; B62J 27/00; A61G 3/061; A61G 3/0808; B62K 5/025; B62M 7/12; B62K 5/06; B62J 9/27; B62J 9/28; B62J 9/30; B62J 45/42; B62J 45/20; B62D 51/02

(57) ABSTRACT

The present invention relates to a personal transporter. The transporter includes a support for supporting a driver. Three or more ground engaging devices are provided for engaging the ground during transport. An electric drive is provided for driving at least one of the ground engaging devices to propel the transporter. A handle bar is provided for enabling the driver to control at least one of the ground engaging devices to steer the transporter. Advantageously, three or more ground engaging devices provide improved stability and may carry greater loads when compared with the two wheels of a Segway.

### TECHNICAL FIELD

The present invention relates to a personal transporter. The present invention has particular, although not exclusive application to a recreational personal transporter.

### BACKGROUND

The reference to any prior art in this specification is not, and should not be taken as an acknowledgement or any form of suggestion that the prior art forms part of the common general knowledge.

Personal transporters such as bicycles and skateboards are well known.

In recent times, electric personal transporters such as those produced by Segway™, with two supporting wheels, have also become quite popular. A Segway is generally for off road use, typically on pathways and bikeways, for either recreational and/or general commuter use. However, a Segway is quite unstable making it unsuitable and somewhat restricted in its application.

Embodiments of the present invention provide for a more stable recreational personal transporter with more applications than a Segway.

### SUMMARY OF THE INVENTION

According to one aspect of the present invention, there is provided a personal transporter including:

a support for supporting a standing or wheelchair bound driver;

three or more ground engaging devices for engaging the ground during transport;

an electric drive for driving at least one of the ground engaging devices to propel the transporter;

a handle bar for enabling the driver to control at least one of the ground engaging devices to steer the transporter; and

a unitary barred frame extending from the handlebar and bending to support the support; and

a safety device which engages the ground during transport responsive to a front one of the ground engaging devices lifting up off the ground to impede flipping of the transporting transporter.

Advantageously, three or more ground engaging devices provide improved stability and may carry greater loads when compared with the two wheels of a Segway.

The transporter may include three ground engaging devices in the form of one front ground engaging device and two rear ground engaging devices. The rear ground engaging devices may be angled toward each other for improved stability. The transporter may include an oblique steering arm extending between the handle bar and front ground engaging device for improved stability. The frame may include a pair of oblique arms supporting respective rear ground engaging devices. The angle between the steering arm and oblique arms supporting respective rear ground engaging devices may be between 70 and 80 degrees. The frame may include metal alloy, steel, carbon fibre, aluminium and/or chrome molybdenum steel.

The ground engaging devices may further include two releasably fastenable support ground engaging devices to support heavier loads. Each ground engaging device may include a wheel. One or more of the wheels may include an electric motor. The electric motor may include a hub stator, and a rotor surrounding the hub stator. The wheel may include a rim, and spokes extending from the rotor to the rim.

The transporter may further include a brake assembly for braking the wheel. The brake assembly may include a brake ring coupled to the rotor. The brake assembly may further include a brake pad for engaging with the brake ring. The brake pad may engage the brake ring at either multiple locations or at a single location. The braking system may be a regenerative braking system.

Each wheel may include an inflatable tyre. A front wheel may be larger than rear wheels for children. At least one of the ground engaging devices may include a skid or track.

In one embodiment, the three or more ground engaging devices consist of three wheels, the wheels including a larger front wheel and a pair of smaller rear wheels, the rear wheels configured to slide during drifting maneuvering of the transporter. The wheels may include grip-less covers. The grip-less covers may be molded rings located around tires which, in turn, can then be inflated to hold the rings in place. The safety device includes may include a tail wheel which engages the ground as the transporter performs a wheelie with the front wheel off the ground. The transporter may be trick maneuvered so that only the front wheel and one of the rear wheels remains in contact with the ground when moving.

The transporter may be configured to perform a zero turn with a turning radius that is substantially zero. The zero turn can be performed even with a trailer connected The front wheel may be rotated in excess of 270°, and preferably through 360°.

The transporter may further include disc brakes. The handle bar may include a brake actuator for actuating the brakes. The handle bar may further include a drive actuator for actuating the electric drive. The drive actuator may be hand grip controlled or digit (e.g. finger or thumb) actuated. The transporter may further include independent suspension for each ground engaging device. The suspension may include a compression spring.

The electric drive may include an electric motor. The motor may be driven in reverse. The electric drive may further include a gearbox coupled between the motor and the ground engaging devices. The electric drive may drive a front one of the ground engaging devices. The electric drive may drive a rear pair of the ground engaging devices. The transporter may further include a rechargeable battery for powering the electric drive. The depleted battery may be replaced with a pre-charged replacement battery. Alternatively, the depleted battery may be charged either whilst removed from or remaining on the transporter. The battery may be fastened to the frame of the transporter. Alternatively, the battery may be located beneath the support. The transporter may further include a charger for charging the battery.

The transporter may be collapsible for storage. The transporter may include a retractable steering arm. The steering arm may pivot. The support may include a platform for supporting the driver. The platform may be sized to support two forward facing feet. The platform may be sized to accommodate a wheel chair. The platform may be supported by three oblique arms.

The transporter may include a holder for holding accessories. The holder may hold any one of: golf clubs, a gun, a cross bow, camping equipment, a drink bottle and bags. The driver may stand when driving the transporter. Alternatively, the transporter may further include a seat. The transporter may have a GPS for locating the transporter in the event of theft. The transporter may transport a single person, being the driver. The transporter may be suitable for off road use.

The transporter may include a trailer.

The transporter may include a delivery container. The transporter may further include a heater or cooler for controlling the internal temperature of the container. The container may be releasable relative to the support. The container may support payloads in excess of 200 kg. The container may include a proximity lock for locking when a key is not detected within a predefined proximity of the container. The transporter may include a barrier on one side only for impeding dismounting of the driver from that side.

The transporter may further include another container (e.g. cleaning container) for substituting the container. The transporter may further include a camera. The camera may be mounted on a pole. The transporter may further include an enclosure for enclosing a passenger.

The support may be configured to support a wheelchair. The transporter may include a loading means to facilitate rear loading of the wheel chair. The loading means may include any one of a ramp, the support which is angled or slides. The ramp may be folded to form a rear barrier. The transporter may further include side barriers to impede sideways slipping of the wheelchair from the support. The wheelchair may be located so that a driver of the transporter is seated in the wheelchair. The transporter may include a lock for locking the wheelchair in place. The handlebar may include inside and outside hand grips for each hand. The handlebar may further include controllers for actuation when a hand is on either grip.

The transporter may include a speed limiter. The speed limiter may limit the speed of the transporter based upon the activation of a lock, in accordance with an entered speed threshold, or a speed limit of a zone in which the transporter is located.

The transporter may include no axle, or axle-less wheels, so that the support can be situated at or beneath the centre of the rear wheels to provide a low centre of gravity and improve stability.

The transporter may include a carriage mounted forward of the support using an articulator. The carriage may include one of the ground engaging devices in the form of a skid.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of an adult personal transporter;

FIG. 2 is a side view of the personal transporter of FIG. 1;

FIG. 3 is a front view of the adult personal transporter of FIG. 1;

FIG. 4 is a perspective view of a snow personal transporter;

FIG. 5 is a perspective view of a children's personal transporter;

FIG. 6 is a perspective view of a wheelchair personal transporter;

FIG. 7 is a perspective view of an off-road personal transporter with trailer;

FIG. 8 is a perspective view of a golf personal transporter;

FIG. 9 is a perspective view of a drifting personal transporter;

FIG. 10a is a perspective view of a wheel assembly of a personal transporter;

FIG. 10b is a side view of the wheel assembly of FIG. 10a;

FIG. 10c is an end view of the wheel assembly of FIG. 10a;

FIG. 10d is a side view of the wheel assembly of FIG. 10a showing the disc brakes;

FIG. 11a is a perspective view of a wheel assembly of a personal transporter;

FIG. 11b is a side view of the wheel assembly of FIG. 11a;

FIG. 11c is an end view of the wheel assembly of FIG. 11a;

FIG. 11d is a side view of the wheel assembly of FIG. 11a showing the disc brakes;

FIG. 12 shows a delivery transporter;

FIG. 13 shows a cleaning transporter converted from the delivery transporter of FIG. 12;

FIG. 14 shows a television coverage transporter converted from the delivery transporter of FIG. 12;

FIG. 15 shows an alternative wheelchair transporter;

FIG. 16 the transporter of FIG. 15 with a handlebar in an upright position for a standing driver; and

FIG. 17 shows a golf transporter 1700.

### DETAILED DESCRIPTION OF PREFERRED EMBODIMENTS

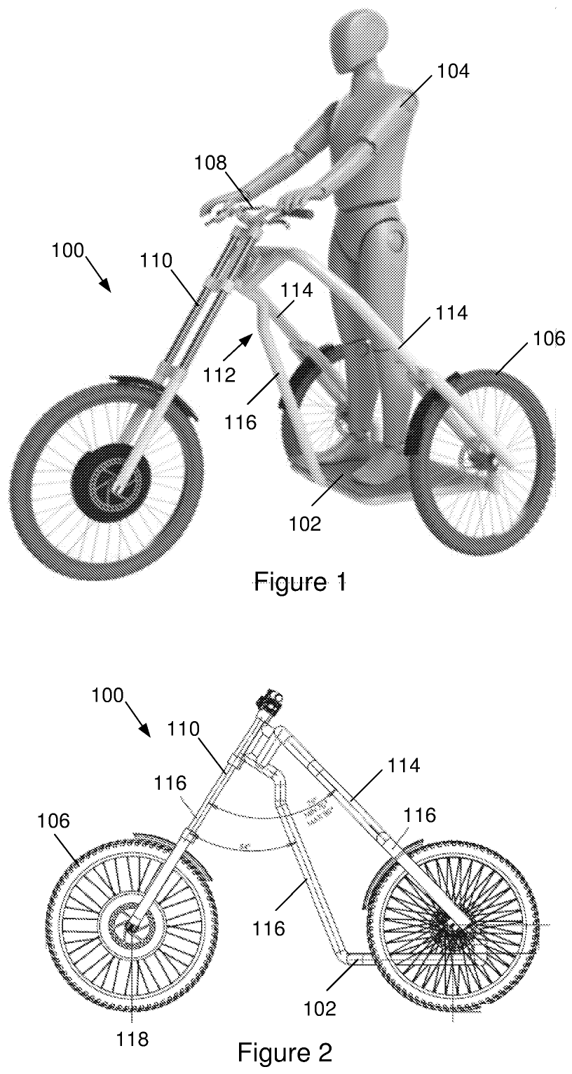

According to one embodiment of the present invention, there is provided an adult personal transporter 100 as shown in FIG. 1. The transporter 100 includes a support 102 for supporting a standing driver 104. Three wheels 106 (i.e. ground engaging devices) engage the ground during transport. An electric drive (not shown) is provided for driving at least one of the wheels 106 to propel the transporter 100. The transporter 100 also includes a handle bar 108 for enabling the driver 104 to control at least one of the wheels 106 to steer the transporter 100. Advantageously, the three wheels 106 provide improved dynamic stability and balance, and can carry greater loads when compared with the two wheels of a Segway.

The transporter 100 includes three wheels 106 in the form of one front wheel and two rear wheels. The transporter 100 includes an oblique steering arm 110 for improved stability, and that extends between the handle bar 108 and front wheel 106 which it steers. The handle bar 108 controls the single front wheel 106. The transporter 100 also includes an overall frame 112 including a pair of rearwardly extending oblique arms 114 supporting respective rear wheels 106.

As can best be seen in FIG. 2, the angle between the steering arm 110 and oblique arms 114 is between 70 and 80 degrees. Another oblique arm 116 extends from the handle bar 108 to support the front of the support 102. The angle between the steering arm 110 and the other arm 116 is about 54 degrees. The frame 112 is lightweight and includes metal alloy, steel, carbon fibre, aluminium and/or chrome molybdenum steel. The transporter 100 further includes independent shock suspension 116 for each wheel. The suspension 116 includes a concealed compression spring.

Each wheel 106 includes an inflatable tyre which can be low pressure for off-road use. The transporter 100 further includes disc brakes 118 on each wheel 106. The handle bar 108 includes a brake actuator for actuating the brakes 118. The handle bar 108 further includes a drive actuator for actuating the electric drive. The drive actuator can be hand grip controlled or digit (e.g. finger or thumb) actuated.

The electric drive includes an electric motor. The electric drive can further include a gearbox coupled between the motor and the wheels 106. The electric drive typically drives the front wheel 106 and/or the rear pair of wheels 106. The transporter 100 further includes a rechargeable battery for powering the electric drive. The depleted battery can be replaced with a pre-charged replacement battery. Alternatively, the depleted battery can be charged either whilst removed from or remaining on the transporter 100. The battery can be either fastened to a frame of the transporter or located beneath the support 102. The transporter 100 further includes a charger for charging the battery.

The support 102 includes a platform for supporting the standing adult driver 104. The platform is sized to support two forward facing feet. The transporter 100 also has a GPS for locating the transporter 100 in the event of theft.

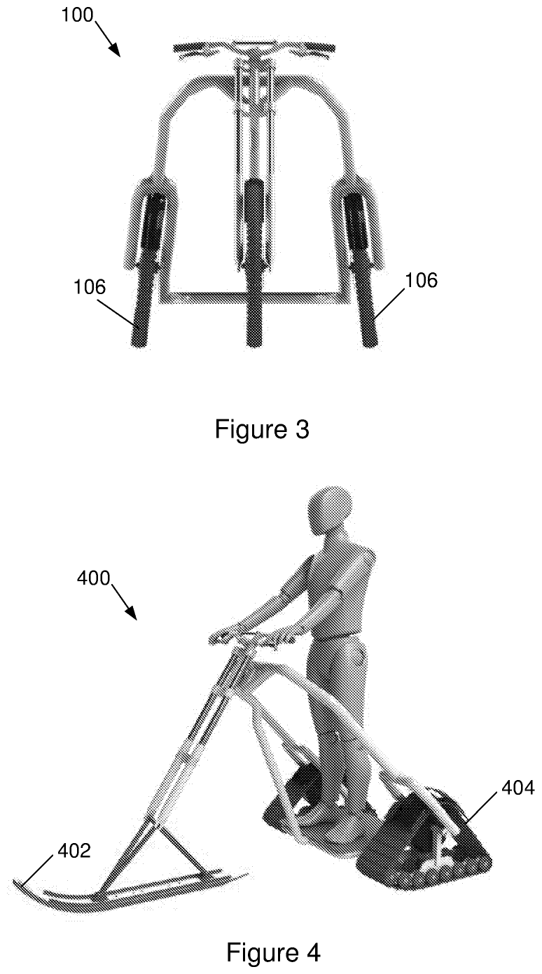

FIG. 3 shows that the outer rear wheels 106 of transporter 100 can be angled toward each other for improved stability.

FIG. 4 shows a snow personal transporter 400 with a front skid 402 (i.e. ground engagement means) and a pair of rear tracks 404 (i.e. ground engagement means).

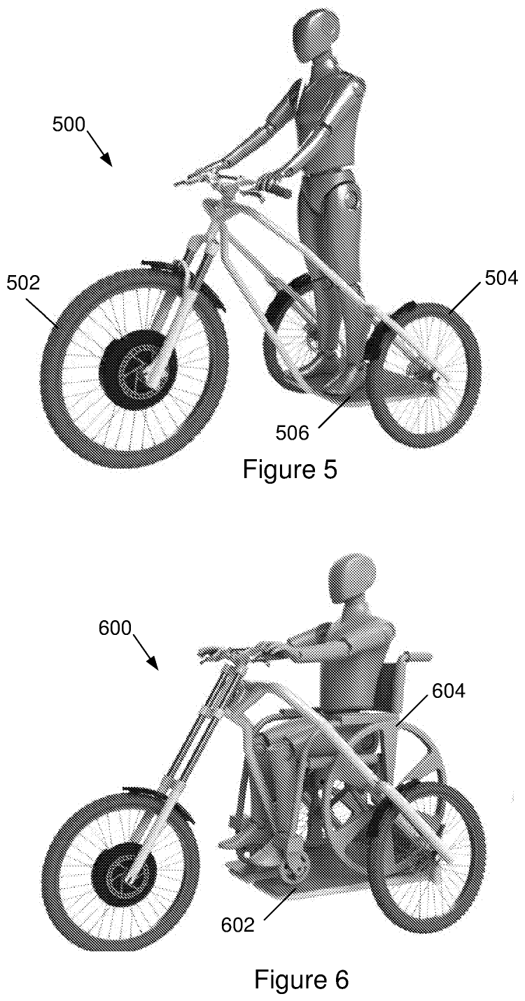

FIG. 5 shows a child's personal transporter 500. The front wheel 502 is larger than the rear wheels 504 to facilitate steering and lowering the standing platform 506 for children. FIG. 6 shows a wheelchair personal transporter 600 with a platform 602 sized to accommodate a wheel chair 604.

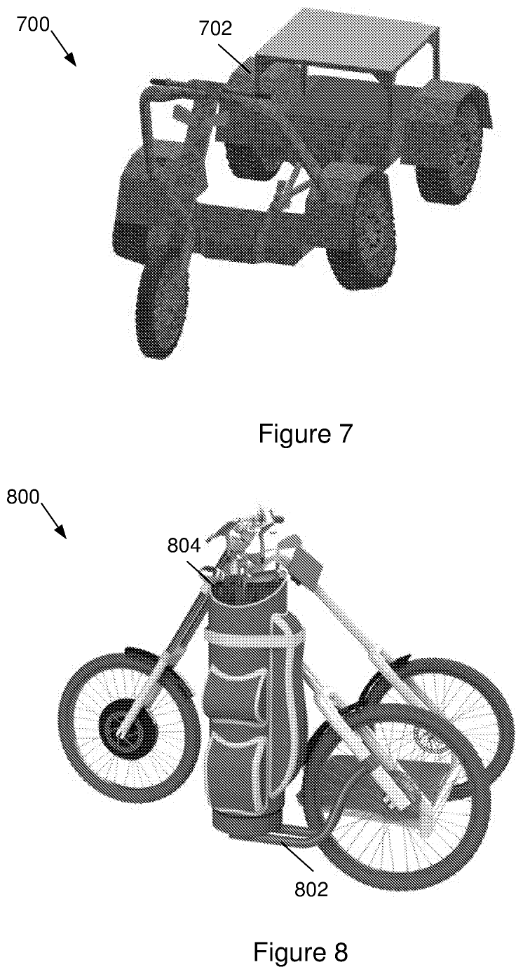

FIG. 7 shows an off-road personal transporter 700 with releasable trailer 702. The robust transporter 700 is suitable for military operations.

FIG. 8 shows a golf personal transporter 800. The transporter 800 includes a holder 802 for holding golf clubs 804. Other holders may be provided for holding other accessories. The holders can hold any one of: a gun, a cross bow, camping equipment, a drink bottle and bags.

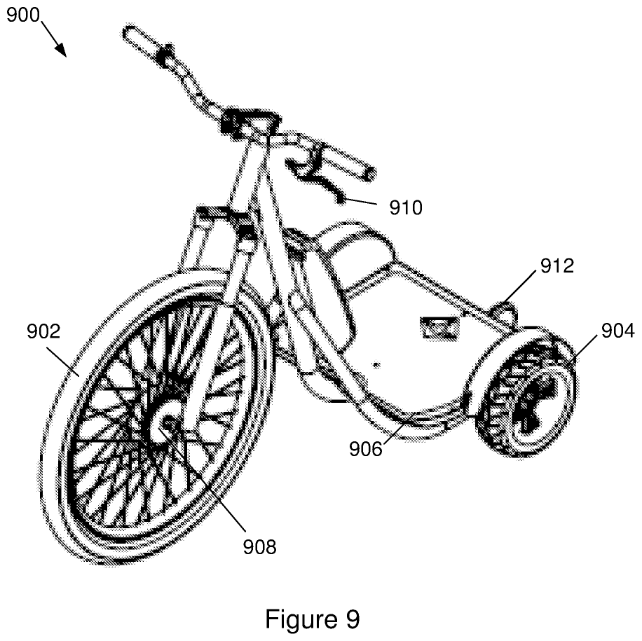

FIG. 9 shows a drifting personal transporter 900, similar to the child's personal transporter 500. The front wheel 902 is larger than the rear wheels 904 to facilitate steering and lowering the standing platform 906 for children. The rear wheels 904 are configured to slide out during drifting maneuvering of the transporter 900. In particular, the wheels 904 either include grip-less covers or can be molded from thermoplastic material to provide a smooth and rigid ground contacting surface. The grip-less covers are moulded rings located around tires which can then be inflated to hold the rings in place.

An electric motor drives the front wheel 902, and disc brakes 908 retard rotation of the front wheel 902 responsive to pulling a hand brake actuator 910. In practice, the driver can actuate the electric motor and disc brakes 908 to control the degree of slide of the rear end of the transporter 900 during drifting. The transporter 900 can be maneuvered to: travel in a straight line, slide out to rotate through 360 degrees, and then continue in a straight line once more. The wheels also include a smaller tail wheel 912, at the back of the platform 906, that engages the ground as the transporter 900 performs a wheelie with the front wheel 902 off the ground. In use, the transporter 900 can be trick maneuvered so that only the front wheel 902 and one of the rear wheels 904 remains in contact with the ground when moving.

The transporter 900 can perform a zero turn with a turning radius that is substantially zero, even with a trailer connected. In particular, by turning the driven front wheel 902 at 90° to the rear wheels 904, the transporter can turn with the free rear wheels 904 remaining about the same location. In fact, the front wheel 902 can be rotated in excess of 270°, and through 360°.

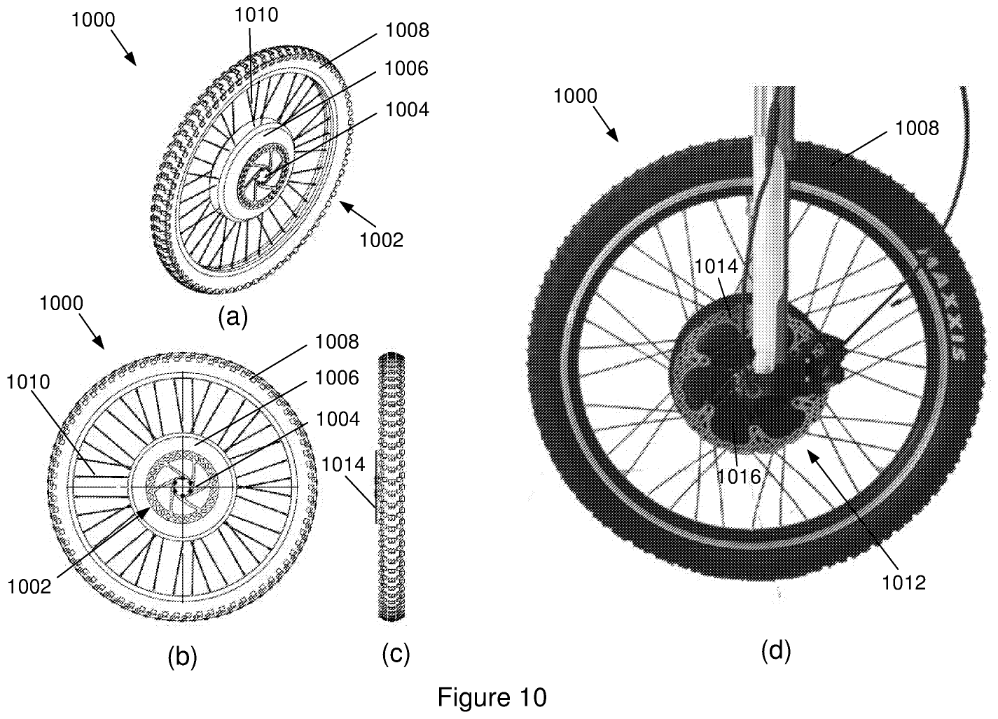

FIG. 10 shows a wheel 1000, whether a front wheel 902 or one of the rear wheels 904. The wheel 1000 includes a lightweight central electric motor 1002. The highly efficient electric motor 1002 includes a hub stator 1004 including armature windings, and a rotor 1006 surrounding the hub stator 1004. The wheel 1000 also includes an outer rim 1008, and spokes 1010 extending from the rotor 1006 to the rim 1008. The motor 1002 may be driven in reverse.

Turning to FIG. 10d, the transporter furthers include a anti-locking brake assembly 1012 for braking the wheel 1000. The brake assembly 1021 includes a brake ring 1014 coupled to the rotor 1006. The brake assembly 1021 further includes a clover-shaped brake pad 1016 for engaging with the brake ring 1014. The rubber brake pad 1016 engages the brake ring 1014 at multiple locations.

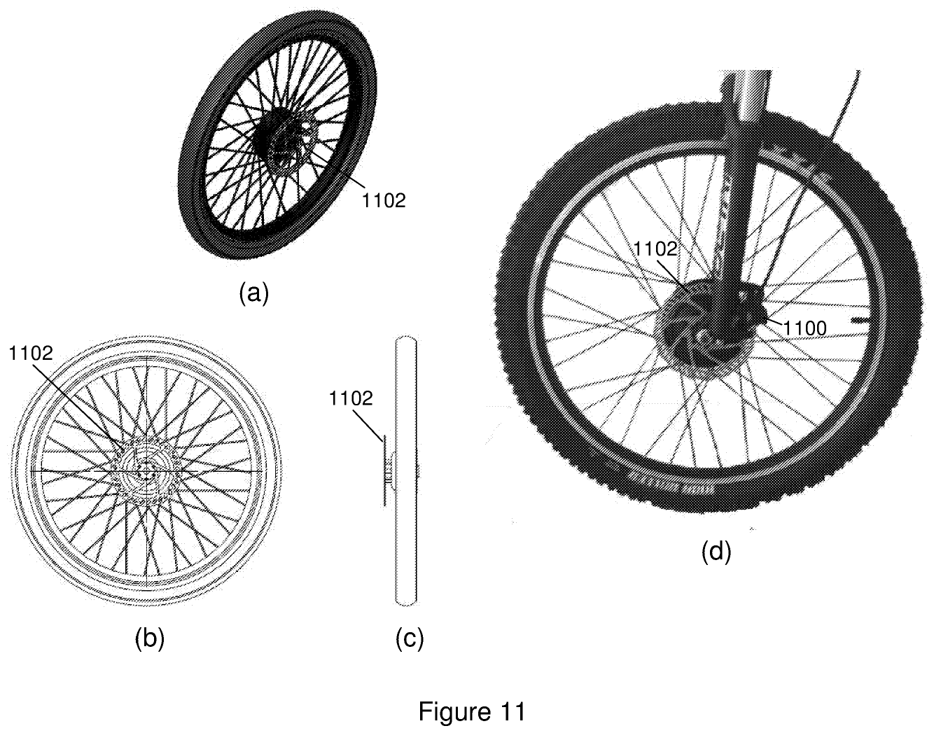

FIG. 11 shows an alternative braking assembly where the rubber brake pad 1100 engages the brake ring 1102 at a single location.

The braking systems above may be regenerative braking systems which convert the kinetic energy of the wheel into electricity stored in the battery during braking.

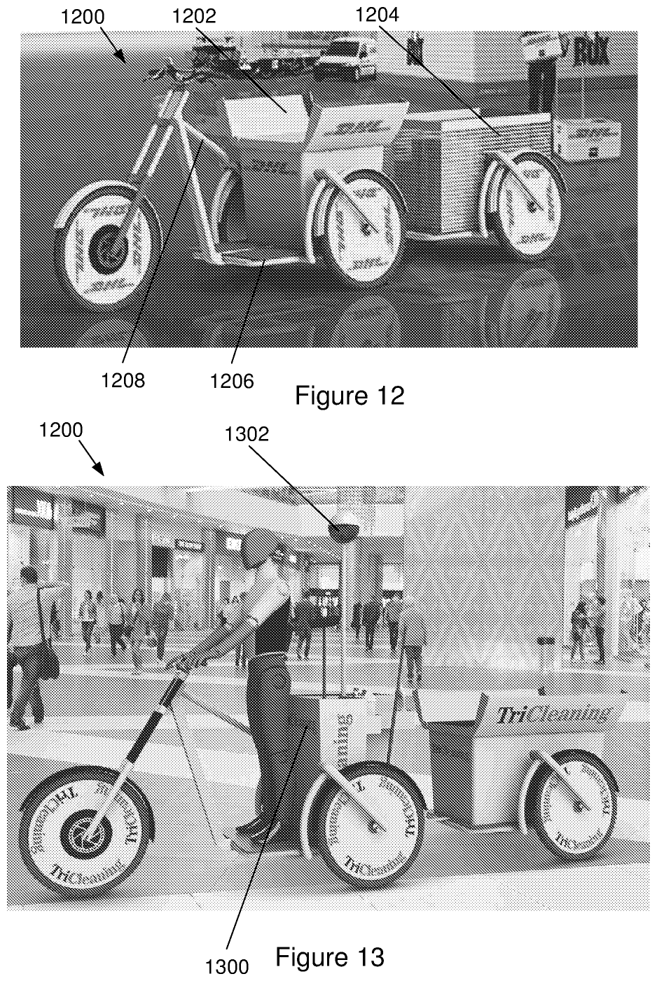

FIG. 12 shows a transporter 1200 fitted with a delivery container 1202 and a trailer 1204. The container 1202 includes a proximity lock for locking the container 1202 when a key is not detected within a predefined proximity of the container 1202. Typically, the driver is a courier carrying the key so that items can be removed from the container 1202 and then the container 1202 is locked when the driver leaves the transporter 1200 to deliver the items. The transporter 1200 includes a rail barrier 1208 on one side only (traffic side) for impeding dismounting of the driver from that side. The container 1202 supports payloads in excess of 200 kg and so the transporter 1200 is robust.

The transporter 1200 further includes a heater or cooler for controlling the internal temperature of the container 1202 when delivering heated goods (e.g. pizzas) and chilled goods (ice cream) respectively. The container 1202 is a module and releasable relative to the driver support 1206.

Turning to FIG. 13, the transporter 1200 further includes another cleaning container 1300 for substituting the packages container 1202. The transporter 1200 can further include a pole-mounted surveillance camera 1302 to capture and transmit images to security in a shopping centre.

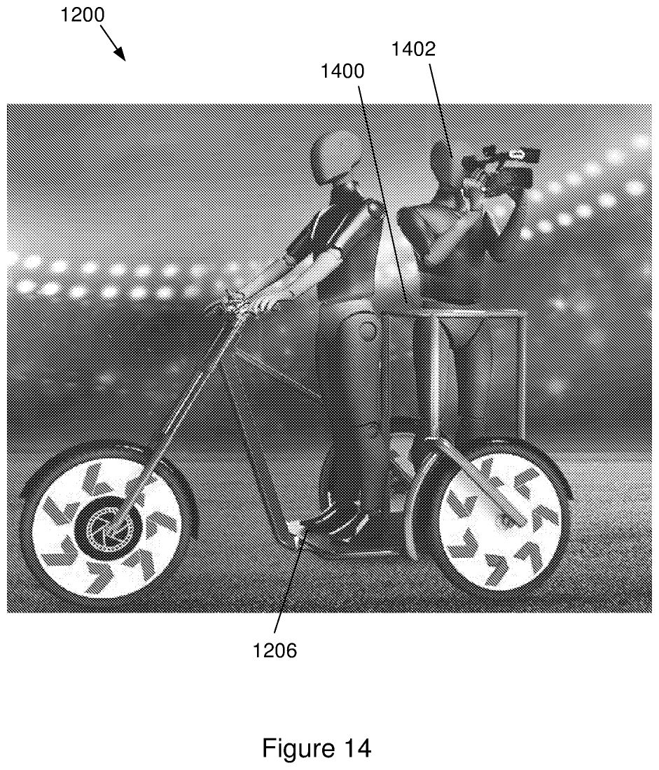

Turning to FIG. 14, the transporter 1200 further includes an safety enclosure 1400 for substituted in place of the packages container 1202. The safety enclosure 1400 for encloses a standing cameraman 1402 (e.g. passenger) taking images at a sporting event.

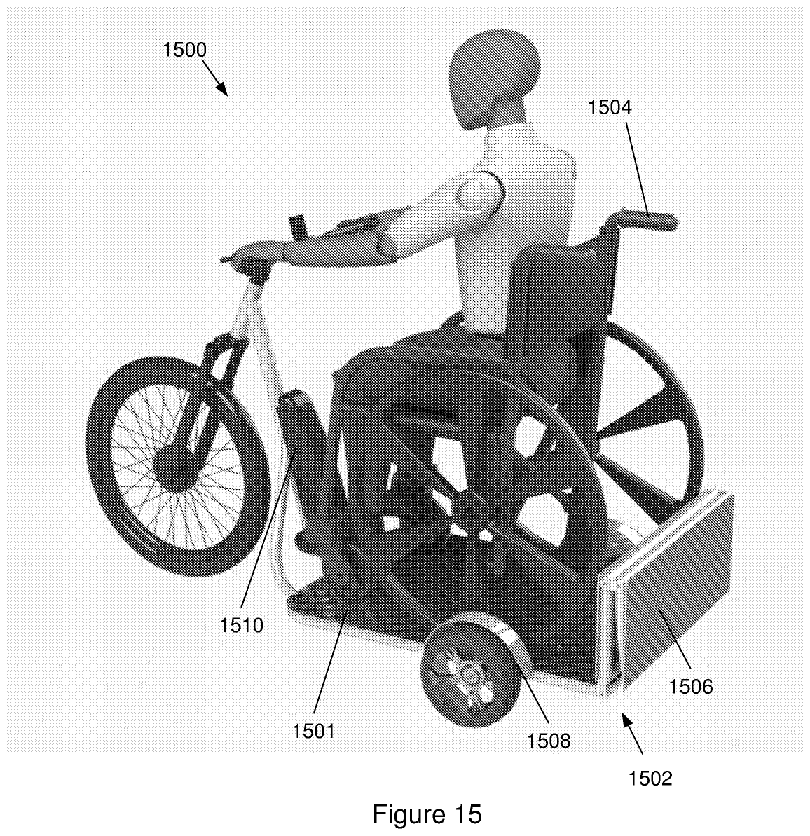

FIG. 15 shows an alternative wheelchair transporter 1500 in which the support 1501 is configured to support a wheelchair 1502. The transporter 1500 includes a loading means 1502 to facilitate rear loading of the wheel chair 1504 onto the support 1501. The loading means 1502 includes a foldable ramp 1506 which can be folded and locked in place to form a rear barrier to the wheelchair 1504 inadvertently falling from the rear of the transporter 1500. Furthermore, rear wheel hubs 1508 prevent sideways slipping of the wheelchair 1504 from the support 1501. In an alternative embodiment, the loading means 1502 includes the support 1501 which is at least in part angled toward the ground or slides for extending from the support 1501 to the ground.

The wheelchair 1504 can be located so that a driver of the transporter is seated in the wheelchair. The transporter 1500 further includes a lock for locking the wheelchair 1504 in place. The transporter 1504 further includes a speed limiter. The speed limiter limits the speed of the transporter 1500 based upon the activation of the lock, in accordance with an entered speed threshold (e.g. 20 km/h), or a received speed limit of a zone in which the transporter is located that is RF transmitted to the transporter 1500 by a governance authority. The battery 1510 is fastened to a frame of the transporter 1500.

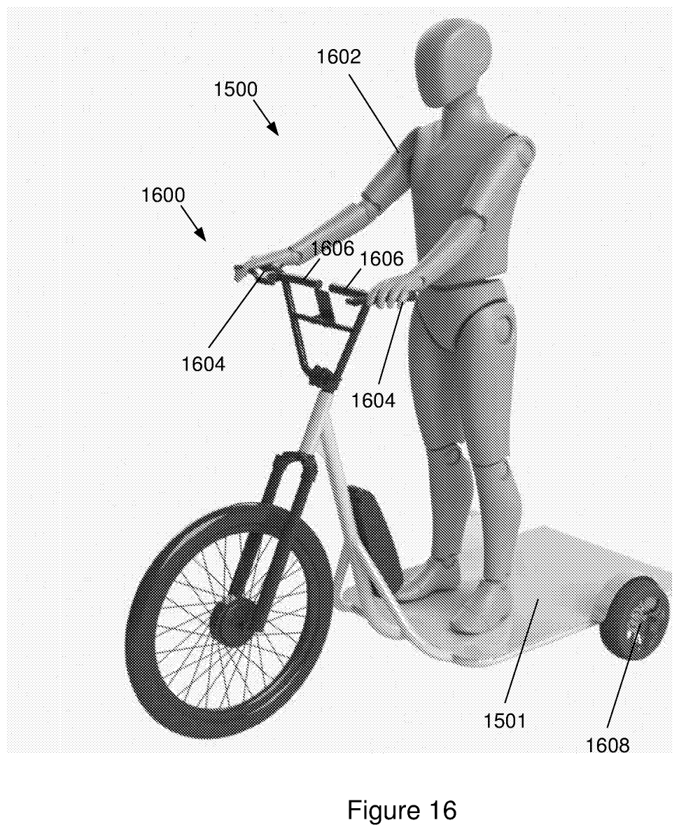

FIG. 16 shows the wheelchair transporter 1500 with a handlebar 1600 moved into an upright position for a standing driver 1602. The handlebar 1600 includes an inside handgrip 1604 and an outside handgrip 1606 for each hand. The handlebar 1600 further includes controllers for actuation when a hand is on either grip 1604, 1606.

The transporter 1500 includes no axle, or axle-less rear wheels 1608, so that the support 1501 can be situated at or beneath the centre of the rear wheels 1608 to provide a low centre of gravity and improve stability.

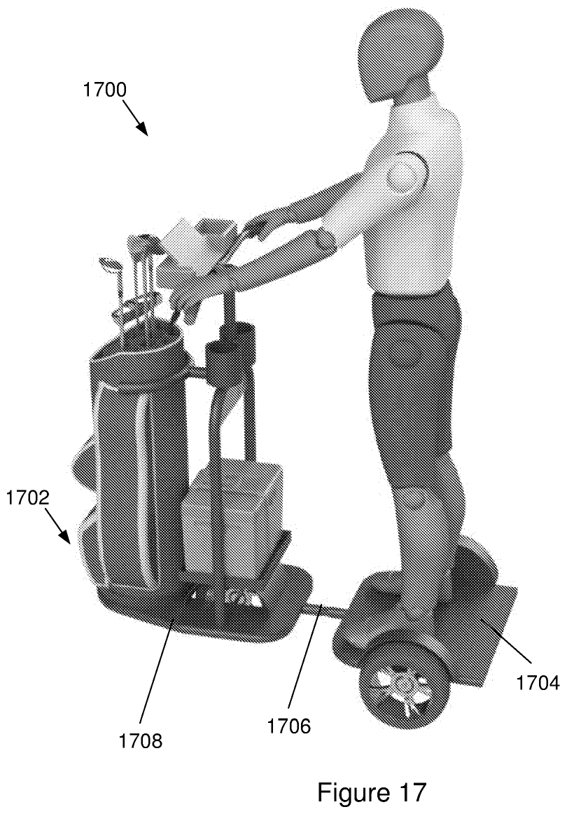

FIG. 17 shows a golf transporter 1700. The transporter 1700 includes a carriage 1702 mounted forward of the driver support 1704 using an interconnecting articulator 1706. The articulator 1706 enables the carriage 1702 two pivot about the support 1704. The carriage 1702 includes a track or skid 1708.

A person skilled in the art will appreciate that many embodiments and variations can be made without departing from the ambit of the present invention.

The transporter 100 can further include two more releasably fastenable wheels to support heavier loads.

Models of the transporter can vary widely based on size and application. Applications can include kids, adult, wheelchair, commuter, sports (i.e. golf cart), ski and specialized (ie. military, hunting, security). Some models have mudguards.

The transporter 100 can be collapsible for storage. In particular, the transporter may include a pivotally retractable steering arm 110 that folds toward the arm 116.

The transporter 100 could be registered in certain jurisdictions for use on road if required. For example, the transporter 100 would have application in highly urbanised environments such as cities like London, or densely populated cities in Northern Europe or in Asia. The transporter 100 could be highly advantageous for personal commuting to and from work or other important places for lifestyle/support needs (i.e. to and from shops, medical offices, or appts with professional services).

In one embodiment, each wheel 1000 of the transporter is fitted with a driving motor 1002 for improved traction.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A personal transporter including:
a support for supporting a standing or wheelchair bound driver;
three or more ground engaging devices for engaging the ground during transport;
an electric drive for driving at least one of the ground engaging devices to propel the transporter;
a handle bar for enabling the driver to control at least one of the ground engaging devices to steer the transporter;
a unitary barred frame extending from the handlebar and bending to support the support; and
a safety device which engages the ground during transport responsive to a front one of the ground engaging devices lifting up off the ground to impede flipping of the transporting transporter.

2. A personal transporter as claimed in claim 1, wherein the ground engaging devices consist of three wheels.

3. A personal transporter as claimed in claim 2, wherein the wheels include a larger front wheel and a pair of smaller rear wheels, the rear wheels configured to slide during drifting maneuvering of the transporter.

4. A personal transporter as claimed in claim 3, wherein the rear wheels include grip-less covers in the form of molded rings located around tires which, in turn, can then be inflated to hold the rings in place, and/or wherein the transporter can be trick maneuvered so that only the front wheel and one of the rear wheels remains in contact with the ground when moving.

5. (canceled)

6. A personal transporter as claimed in claim 1, wherein the safety device includes a tail wheel which engages the ground as the transporter performs a wheelie with a front wheel off the ground.

7. A personal transporter as claimed in claim 1, wherein the transporter is configured to perform a zero turn with a turning radius that is substantially zero.

8. A personal transporter as claimed in claim 7, wherein only a front ground engaging device is driven whereas rear ones are not.

9. A personal transporter as claimed in claim 7, wherein the zero turn can be performed even with a trailer connected

10. A personal transporter as claimed in claim 7, wherein a front one of the ground engaging devices can be rotated in excess of 270°, and preferably through 360°.

11. A personal transporter as claimed in claim 1, wherein each ground engaging device includes a wheel and one or more of the wheels include an electric motor, the electric motor including a hub stator, and a rotor surrounding the hub stator.

12. A personal transporter as claimed in claim 11, wherein each wheel with an electric motor includes a rim, and spokes extending from the rotor to the rim.

13. A personal transporter as claimed in claim 11, further including a brake assembly for braking at least one of the wheels.

14. A personal transporter as claimed in claim 13, wherein the braking system is a regenerative braking system for converting kinetic energy of the wheel into electricity stored in a battery.

15. (canceled)

16. A personal transporter as claimed in claim 15, wherein the transporter includes a heater or cooler for controlling the internal temperature of the container, and/or wherein the container may be releasable relative to the support or the transporter further includes another container for substituting the container, and/or wherein the container can support payloads in excess of 200 kg, and/or wherein the container includes a proximity lock for locking when a key is not detected within a predefined proximity of the container.

17-19. (canceled)

20. A personal transporter as claimed in claim 1, further including at least one of:
a delivery container;
a barrier on one side only for impeding dismounting of the driver from that side;
a pole-mounted camera;
an enclosure for enclosing a passenger; or
a speed limiter for limiting the speed of the transporter based upon the activation of a lock, in accordance with an entered speed threshold, or a speed limit of a zone in which the transporter is located.

21. (canceled)

22. (canceled)

23. A personal transporter as claimed in claim 1, wherein the support is configured to support a wheelchair in which the driver of the transporter is located.

24. A personal transporter as claimed in claim 23, including a loading means to facilitate rear loading of the wheel chair.

25. A personal transporter as claimed in claim 24, wherein the loading means includes a ramp which can be folded to form a rear barrier.

26. A personal transporter as claimed in claim 25, wherein the transporter further includes side barriers to impede sideways slipping of the wheelchair from the support or a lock for locking the wheelchair in place.

27. A personal transporter as claimed in claim 1, wherein the handlebar includes inside and outside hand grips for each hand, and/or including no axle, or axle-less wheels, so that the support can be situated at or beneath the centre of the rear wheels to provide a low centre of gravity and improve stability.

28. (canceled)

29. (canceled)
